(19) United States
(12) Patent Application Publication
(10) Pub. No.: US 2020/0042890 A1
(43) Pub. Date: Feb. 6, 2020

(54) AUTOMATIC PREDICTION OF YIELDS AND RECOMMENDATION OF SEEDING RATES BASED ON WEATHER DATA

(71) Applicant: THE CLIMATE CORPORATION, San Francisco, CA (US)

(72) Inventors: Hunter R. Merrill, St. Louis, MO (US); Allan Trapp, St. Louis, MO (US)

(21) Appl. No.: 16/528,476

(22) Filed: Jul. 31, 2019

Related U.S. Application Data
(60) Provisional application No. 62/714,052, filed on Aug. 2, 2018.

(51) Int. Cl. G06N 5/04; G06N 20/00

(52) U.S. Cl. CPC G06N 5/048; A01C 7/102; G06N 20/00

(57) ABSTRACT

A computer-implemented method of predicting yields and recommending seeding rates for subfields with informed risks is disclosed. The method comprises receiving, by a processor, weather data for a first period consisting of a plurality of sub-periods for one or more subfields of a field; for each of the plurality of sub-periods for the one subfield: calculating a moisture stress indicator from the weather data; predicting, for each of a list of seeding rates, a yield from the moisture stress indicator using a trained model; and selecting one of the list of seeding rates based on the list of predicted yields; identifying one of the predicted yields corresponding to the selected seeding rate; determining, by the processor, a risk profile associated with a range of yields for the one subfield based on the predicted yields identified for the plurality of sub-periods; transmitting data related to the risk profile to a device associated with the one subfield.

### BENEFIT CLAIM

This application claims priority under 35 U.S.C. § 119 to application 62/714,052, filed Aug. 2, 2018, the entire contents of which are hereby incorporated by reference as if fully set forth herein.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright or rights whatsoever. © 2015-2019 The Climate Corporation.

### FIELD OF THE DISCLOSURE

The present disclosure relates to the technical area of agricultural data management and more specifically to the technical area of predicting soil moisture and yield and prescribing seeding rates with informed risks.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Many factors may affect yields of growers' fields. Conventionally, certain types of soil data are used in predicting yields, such as soil topology data. These types of soil data generally do not include significant variations over relatively short periods of time and by themselves may not be good indicators of yields, which often fluctuate significantly. It would be helpful to consider additional types of soil data in predicting yields, such as soil moisture data affected by often unpredictable weather, especially at a granular subfield level.

Given the potentially large number of fields and subfields and the general cost of installing and maintaining soil moisture probes, it would be further helpful to eliminate the need to probe moisture in every field or every subfield. To achieve this goal, it would be helpful to estimate the soil moisture for certain subfields given measurements by soil moisture probes for other subfields or other data that might be indicative of soil moisture content.

Furthermore, predictions of yields would be more useful when growers know how they might achieve the predicted yields with specificity. Seeding rate has a material effect on yield, and therefore it would be helpful to recommend seeding rates as part of a prescription for achieving the predicted yields.

In addition, the unpredictability of weather means inherent risk in any weather-based prediction. Therefore, it would be helpful to estimate the risk associated with a predicted yield and the corresponding seeding rate.

### SUMMARY

The appended claims may serve as a summary of the disclosure.

### BRIEF DESCRIPTION OF THE DRAWINGS

In the drawings:

FIG. 1 illustrates an example computer system that is configured to perform the functions described herein, shown in a field environment with other apparatus with which the system may interoperate.

FIG. 2 illustrates two views of an example logical organization of sets of instructions in main memory when an example mobile application is loaded for execution.

FIG. 3 illustrates a programmed process by which the agricultural intelligence computer system generates one or more preconfigured agronomic models using agronomic data provided by one or more data sources.

FIG. 4 is a block diagram that illustrates a computer system upon which an embodiment of the invention may be implemented.

FIG. 5 depicts an example embodiment of a timeline view for data entry.

FIG. 6 depicts an example embodiment of a spreadsheet view for data entry.

FIG. 7 illustrates an example relationship between seeding rates and predicted yields.

FIG. 8 illustrates an example distribution of yields forming quantiles.

FIG. 9 illustrates an example computer-generated screen display of a graphical user interface related to a risk profile.

FIG. 10 illustrates an example method performed by a server computer that is programmed for predicting yields and recommending seeding rates for subfields with informed risks.

### DETAILED DESCRIPTION

In the following description, for the purposes of explanation, numerous specific details are set forth in order to provide a thorough understanding of the present disclosure. It will be apparent, however, that embodiments may be practiced without these specific details. In other instances, well-known structures and devices are shown in block diagram form in order to avoid unnecessarily obscuring the present disclosure. Embodiments are disclosed in sections according to the following outline:

1. GENERAL OVERVIEW

2. EXAMPLE AGRICULTURAL INTELLIGENCE COMPUTER SYSTEM
2.1. STRUCTURAL OVERVIEW
2.2. APPLICATION PROGRAM OVERVIEW
2.3. DATA INGEST TO THE COMPUTER SYSTEM
2.4. PROCESS OVERVIEW—AGRONOMIC MODEL TRAINING
2.5. IMPLEMENTATION EXAMPLE—HARDWARE OVERVIEW

3. FUNCTIONAL DESCRIPTIONS
3.1 COLLECTING TRAINING DATA OF SOIL PROPERTIES AND YIELDS
3.2 ESTIMATING MOISTURE DATA
3.3 BUILDING A YIELD PREDICTION MODEL
3.4 COLLECTING SOIL PROPERTIES OF TARGET FIELDS
3.5 DETERMINING OPTIMAL SEEDING RATES AND CORRESPONDING PREDICTED YIELDS
3.6 DETERMINING RISK VALUES ASSOCIATED WITH PREDICTED YIELDS
3.7 GENERATING SEEDING RATE PRESCRIPTIONS
3.8 EXAMPLE PROCESSES

4. EXTENSIONS AND ALTERNATIVES

### 1. General Overview

An agricultural data management process for predicting yields and recommending seeding rates for subfields with informed risks is disclosed. In one embodiment, the process may be computer-implemented using a server computer in a distributed client-server system. In some embodiments, for each of a plurality of subfields of one or more fields and each of a plurality of sub-periods of a certain period, the server is programmed to receive different types of digital soil data, such as soil chemistry data, soil topology data, or field imagery data. The server is programmed to also receive seeding rate data or soil moisture data as well as fertilizer data, seed genetics data, or other field data, as further discussed below. In addition, the server is programmed to receive the corresponding yield data. Based on these data, the server is configured to build a yield prediction model. A “model” in this context refers to an electronic digitally stored set of executable instructions and data values, associated with one another, which are capable of receiving and responding to a programmatic or other digital call, invocation, or request for resolution based upon specified input values, to yield one or more stored or calculated output values that can serve as the basis of computer-implemented recommendations, output data displays, or machine control, among other things.

In some embodiments, the server is programmed to computationally derive the soil moisture data for a certain subfield based on the soil moisture data obtained from moisture probes for other subfields. The server is configured to model a moisture prediction model that captures the relationships in the time dimension and in the space dimension. The measured soil moisture data and the computationally derived soil moisture data are then used to build the yield prediction model.

In some embodiments, the server is programmed to next receive different types of digital soil data, such as soil chemistry data, soil topology data, field imagery data, or soil moisture, for a specific subfield different from the plurality of subfields for a recent sub-period. The server is programmed to execute the yield prediction model on the soil data for the specific subfield with each of a plurality of seeding rates. The seeding rate that produces the highest yield is then considered as the optimal seeding rate.

In some embodiments, the server is programmed to further receive different types of digital soil data for the specific subfield for a plurality of sub-periods of a specific period before the recent time point. The server is programmed to repeat the process of obtaining the optimal seeding rate and the corresponding highest yield for each of the plurality of sub-periods. The server is programmed to further obtain an adjusted seeding rate from the optimal seeding rate for each of the sub-periods by comparing the optimal seeding rate with the optimal seeding rates for at least the neighboring subfields. Furthermore, the server is programmed to determine the adjusted yield corresponding to the adjusted seeding rate.

In some embodiments, the server is programmed to determine a risk profile that reflects based on the adjusted yields for the plurality of sub-periods. The server can be configured to calculate aggregate adjusted yields and corresponding adjusted seeding rates over all the subfields of a field. The server can be configured to then build quantiles of the aggregated adjusted yields with the quantile numbers indicating risk percentages. In addition, the server is programmed to identify the adjusted seeding rates corresponding to the adjusted yields that belong to the quantiles indicating given lower bound and upper bound on the risk and recommend the identified adjusted seeding rates to growers of the subfield or field.

The server produces many technical benefits. The server offers a soil moisture prediction model that captures the complex, multi-dimensional relationships present in the weather system. The soil moisture model further enables accurate yield predictions despite a lack of actual soil measurements. The server further offers a yield prediction model from many different types of soil data, including soil moisture data. The yield prediction model thus accounts for many factors that affect the yields of the fields, including soil moisture that tends to fluctuate due to weather unpredictability. In addition, the server provides prescriptions of seeding rates to growers with informed risks, allowing growers to take actions while understanding what the likely outcomes might be.

Other aspects and features of embodiments will become apparent from other sections of the disclosure.

### 2. Example Agricultural Intelligence Computer System

2.1 Structural Overview

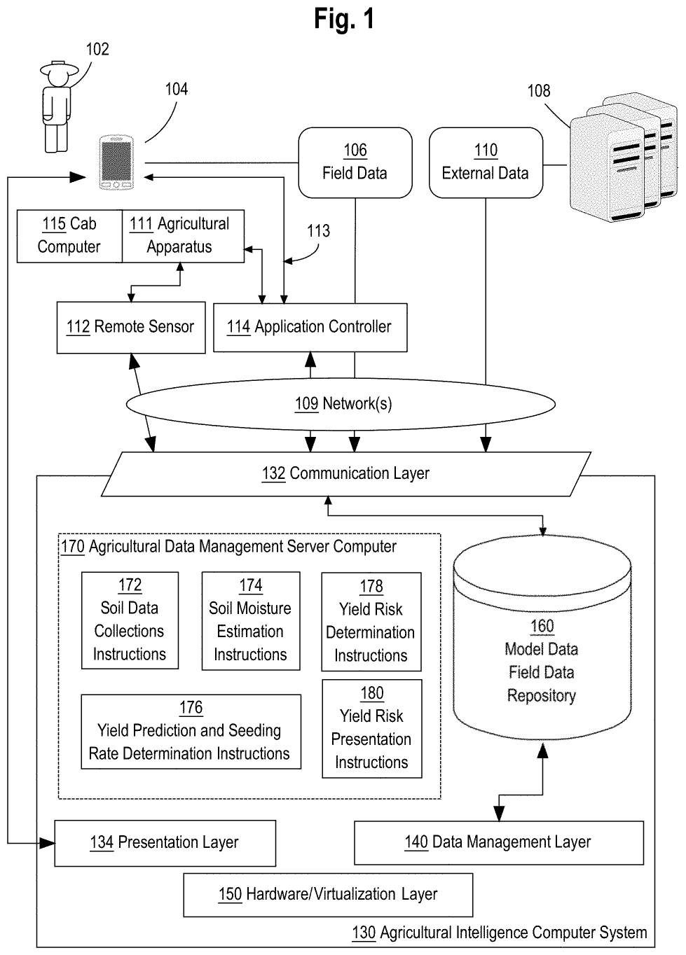

FIG. 1 illustrates an example computer system that is configured to perform the functions described herein, shown in a field environment with other apparatus with which the system may interoperate. In one embodiment, a user 102 owns, operates or possesses a field manager computing device 104 in a field location or associated with a field location such as a field intended for agricultural activities or a management location for one or more agricultural fields. The field manager computer device 104 is programmed or configured to provide field data 106 to an agricultural intelligence computer system 130 via one or more networks 109.

Examples of field data 106 include (a) identification data (for example, acreage, field name, field identifiers, geographic identifiers, boundary identifiers, crop identifiers, and any other suitable data that may be used to identify farm land, such as a common land unit (CLU), lot and block number, a parcel number, geographic coordinates and boundaries, Farm Serial Number (FSN), farm number, tract number, field number, section, township, and/or range), (b) harvest data (for example, crop type, crop variety, crop rotation, whether the crop is grown organically, harvest date, Actual Production History (APH), expected yield, yield, crop price, crop revenue, grain moisture, tillage practice, and previous growing season information), (c) soil data (for example, type, composition, pH, organic matter (OM), cation exchange capacity (CEC)), (d) planting data (for example, planting date, seed(s) type, relative maturity (RM) of planted seed(s), seed population), (e) fertilizer data (for example, nutrient type (Nitrogen, Phosphorous, Potassium), application type, application date, amount, source, method), (f) chemical application data (for example, pesticide, herbicide, fungicide, other substance or mixture of substances intended for use as a plant regulator, defoliant, or desiccant, application date, amount, source, method), (g) irrigation data (for example, application date, amount, source, method), (h) weather data (for example, precipitation, rainfall rate, predicted rainfall, water runoff rate region, temperature, wind, forecast, pressure, visibility, clouds, heat index, dew point, humidity, snow depth, air quality, sunrise, sunset), (i) imagery data (for example, imagery and light spectrum information from an agricultural apparatus sensor, camera, computer, smartphone, tablet, unmanned aerial vehicle, planes or satellite), (j) scouting observations (photos, videos, free form notes, voice recordings, voice transcriptions, weather conditions (temperature, precipitation (current and over time), soil moisture, crop growth stage, wind velocity, relative humidity, dew point, black layer)), and (k) soil, seed, crop phenology, pest and disease reporting, and predictions sources and databases.

A data server computer 108 is communicatively coupled to agricultural intelligence computer system 130 and is programmed or configured to send external data 110 to agricultural intelligence computer system 130 via the network(s) 109. The external data server computer 108 may be owned or operated by the same legal person or entity as the agricultural intelligence computer system 130, or by a different person or entity such as a government agency, non-governmental organization (NGO), and/or a private data service provider. Examples of external data include weather data, imagery data, soil data, or statistical data relating to crop yields, among others. External data 110 may consist of the same type of information as field data 106. In some embodiments, the external data 110 is provided by an external data server 108 owned by the same entity that owns and/or operates the agricultural intelligence computer system 130. For example, the agricultural intelligence computer system 130 may include a data server focused exclusively on a type of data that might otherwise be obtained from third party sources, such as weather data. In some embodiments, an external data server 108 may actually be incorporated within the system 130.

An agricultural apparatus 111 may have one or more remote sensors 112 fixed thereon, which sensors are communicatively coupled either directly or indirectly via agricultural apparatus 111 to the agricultural intelligence computer system 130 and are programmed or configured to send sensor data to agricultural intelligence computer system 130. Examples of agricultural apparatus 111 include tractors, combines, harvesters, planters, trucks, fertilizer equipment, aerial vehicles including unmanned aerial vehicles, and any other item of physical machinery or hardware, typically mobile machinery, and which may be used in tasks associated with agriculture. In some embodiments, a single unit of apparatus 111 may comprise a plurality of sensors 112 that are coupled locally in a network on the apparatus; controller area network (CAN) is example of such a network that can be installed in combines, harvesters, sprayers, and cultivators. Application controller 114 is communicatively coupled to agricultural intelligence computer system 130 via the network(s) 109 and is programmed or configured to receive one or more scripts that are used to control an operating parameter of an agricultural vehicle or implement from the agricultural intelligence computer system 130. For instance, a controller area network (CAN) bus interface may be used to enable communications from the agricultural intelligence computer system 130 to the agricultural apparatus 111, such as how the CLIMATE FIELDVIEW DRIVE, available from The Climate Corporation, San Francisco, Calif., is used. Sensor data may consist of the same type of information as field data 106. In some embodiments, remote sensors 112 may not be fixed to an agricultural apparatus 111 but may be remotely located in the field and may communicate with network 109.

The apparatus 111 may comprise a cab computer 115 that is programmed with a cab application, which may comprise a version or variant of the mobile application for device 104 that is further described in other sections herein. In an embodiment, cab computer 115 comprises a compact computer, often a tablet-sized computer or smartphone, with a graphical screen display, such as a color display, that is mounted within an operator's cab of the apparatus 111. Cab computer 115 may implement some or all of the operations and functions that are described further herein for the mobile computer device 104.

The network(s) 109 broadly represent any combination of one or more data communication networks including local area networks, wide area networks, internetworks or internets, using any of wireline or wireless links, including terrestrial or satellite links. The network(s) may be implemented by any medium or mechanism that provides for the exchange of data between the various elements of FIG. 1. The various elements of FIG. 1 may also have direct (wired or wireless) communications links. The sensors 112, controller 114, external data server computer 108, and other elements of the system each comprise an interface compatible with the network(s) 109 and are programmed or configured to use standardized protocols for communication across the networks such as TCP/IP, Bluetooth, CAN protocol and higher-layer protocols such as HTTP, TLS, and the like.

Agricultural intelligence computer system 130 is programmed or configured to receive field data 106 from field manager computing device 104, external data 110 from external data server computer 108, and sensor data from remote sensor 112. Agricultural intelligence computer system 130 may be further configured to host, use or execute one or more computer programs, other software elements, digitally programmed logic such as FPGAs or ASICs, or any combination thereof to perform translation and storage of data values, construction of digital models of one or more crops on one or more fields, generation of recommendations and notifications, and generation and sending of scripts to application controller 114, in the manner described further in other sections of this disclosure.

In an embodiment, agricultural intelligence computer system 130 is programmed with or comprises a communication layer 132, presentation layer 134, data management layer 140, hardware/virtualization layer 150, and model and field data repository 160. “Layer,” in this context, refers to any combination of electronic digital interface circuits, microcontrollers, firmware such as drivers, and/or computer programs or other software elements.

Communication layer 132 may be programmed or configured to perform input/output interfacing functions including sending requests to field manager computing device 104, external data server computer 108, and remote sensor 112 for field data, external data, and sensor data respectively. Communication layer 132 may be programmed or configured to send the received data to model and field data repository 160 to be stored as field data 106.

Presentation layer 134 may be programmed or configured to generate a graphical user interface (GUI) to be displayed on field manager computing device 104, cab computer 115 or other computers that are coupled to the system 130 through the network 109. The GUI may comprise controls for inputting data to be sent to agricultural intelligence computer system 130, generating requests for models and/or recommendations, and/or displaying recommendations, notifications, models, and other field data.

Data management layer 140 may be programmed or configured to manage read operations and write operations involving the repository 160 and other functional elements of the system, including queries and result sets communicated between the functional elements of the system and the repository. Examples of data management layer 140 include JDBC, SQL server interface code, and/or HADOOP interface code, among others. Repository 160 may comprise a database. As used herein, the term “database” may refer to either a body of data, a relational database management system (RDBMS), or to both. As used herein, a database may comprise any collection of data including hierarchical databases, relational databases, flat file databases, object-relational databases, object oriented databases, distributed databases, and any other structured collection of records or data that is stored in a computer system. Examples of RDBMS's include, but are not limited to including, ORACLE®, MYSQL, IBM® DB2, MICROSOFT® SQL SERVER, SYBASE®, and POSTGRESQL databases. However, any database may be used that enables the systems and methods described herein.

When field data 106 is not provided directly to the agricultural intelligence computer system via one or more agricultural machines or agricultural machine devices that interacts with the agricultural intelligence computer system, the user may be prompted via one or more user interfaces on the user device (served by the agricultural intelligence computer system) to input such information. In an example embodiment, the user may specify identification data by accessing a map on the user device (served by the agricultural intelligence computer system) and selecting specific CLUs that have been graphically shown on the map. In an alternative embodiment, the user 102 may specify identification data by accessing a map on the user device (served by the agricultural intelligence computer system 130) and drawing boundaries of the field over the map. Such CLU selection or map drawings represent geographic identifiers. In alternative embodiments, the user may specify identification data by accessing field identification data (provided as shape files or in a similar format) from the U. S. Department of Agriculture Farm Service Agency or other source via the user device and providing such field identification data to the agricultural intelligence computer system.

In an example embodiment, the agricultural intelligence computer system 130 is programmed to generate and cause displaying a graphical user interface comprising a data manager for data input. After one or more fields have been identified using the methods described above, the data manager may provide one or more graphical user interface widgets which when selected can identify changes to the field, soil, crops, tillage, or nutrient practices. The data manager may include a timeline view, a spreadsheet view, and/or one or more editable programs.

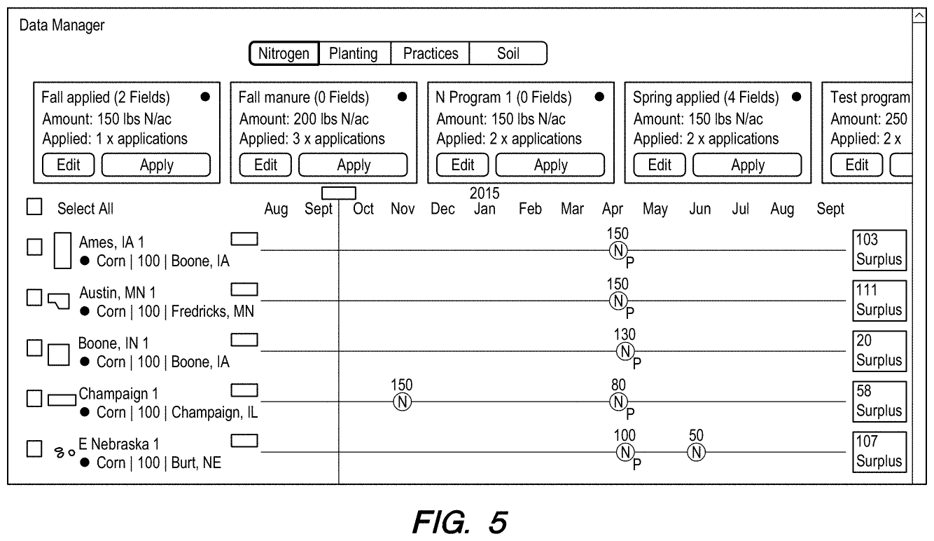

FIG. 5 depicts an example embodiment of a timeline view for data entry. Using the display depicted in FIG. 5, a user computer can input a selection of a particular field and a particular date for the addition of event. Events depicted at the top of the timeline may include Nitrogen, Planting, Practices, and Soil. To add a nitrogen application event, a user computer may provide input to select the nitrogen tab. The user computer may then select a location on the timeline for a particular field in order to indicate an application of nitrogen on the selected field. In response to receiving a selection of a location on the timeline for a particular field, the data manager may display a data entry overlay, allowing the user computer to input data pertaining to nitrogen applications, planting procedures, soil application, tillage procedures, irrigation practices, or other information relating to the particular field. For example, if a user computer selects a portion of the timeline and indicates an application of nitrogen, then the data entry overlay may include fields for inputting an amount of nitrogen applied, a date of application, a type of fertilizer used, and any other information related to the application of nitrogen.

In an embodiment, the data manager provides an interface for creating one or more programs. “Program,” in this context, refers to a set of data pertaining to nitrogen applications, planting procedures, soil application, tillage procedures, irrigation practices, or other information that may be related to one or more fields, and that can be stored in digital data storage for reuse as a set in other operations. After a program has been created, it may be conceptually applied to one or more fields and references to the program may be stored in digital storage in association with data identifying the fields. Thus, instead of manually entering identical data relating to the same nitrogen applications for multiple different fields, a user computer may create a program that indicates a particular application of nitrogen and then apply the program to multiple different fields. For example, in the timeline view of FIG. 5, the top two timelines have the “Spring applied” program selected, which includes an application of 150 lbs N/ac in early April. The data manager may provide an interface for editing a program. In an embodiment, when a particular program is edited, each field that has selected the particular program is edited. For example, in FIG. 5, if the “Spring applied” program is edited to reduce the application of nitrogen to 130 lbs N/ac, the top two fields may be updated with a reduced application of nitrogen based on the edited program.

In an embodiment, in response to receiving edits to a field that has a program selected, the data manager removes the correspondence of the field to the selected program. For example, if a nitrogen application is added to the top field in FIG. 5, the interface may update to indicate that the “Spring applied” program is no longer being applied to the top field. While the nitrogen application in early April may remain, updates to the “Spring applied” program would not alter the April application of nitrogen.

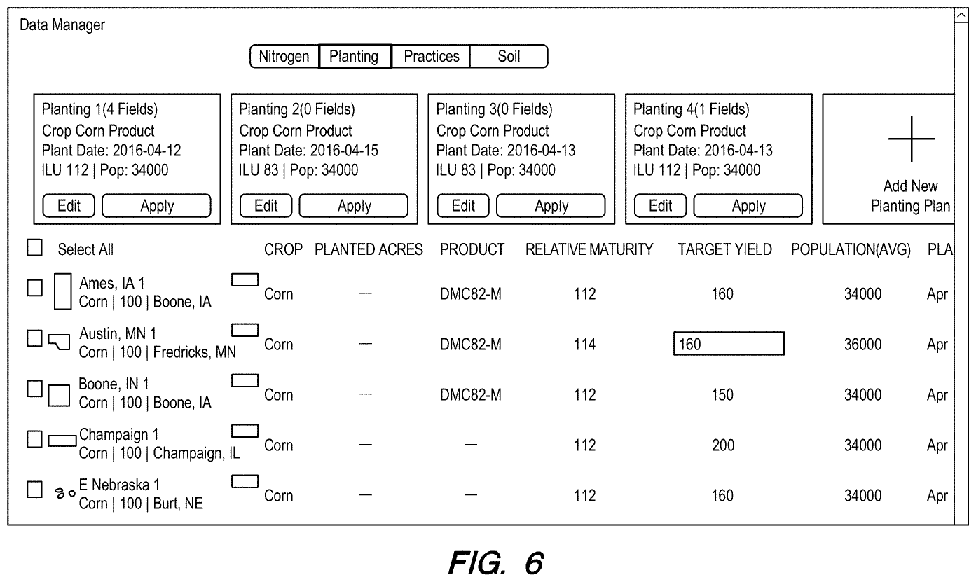

FIG. 6 depicts an example embodiment of a spreadsheet view for data entry. Using the display depicted in FIG. 6, a user can create and edit information for one or more fields. The data manager may include spreadsheets for inputting information with respect to Nitrogen, Planting, Practices, and Soil as depicted in FIG. 6. To edit a particular entry, a user computer may select the particular entry in the spreadsheet and update the values. For example, FIG. 6 depicts an in-progress update to a target yield value for the second field. Additionally, a user computer may select one or more fields in order to apply one or more programs. In response to receiving a selection of a program for a particular field, the data manager may automatically complete the entries for the particular field based on the selected program. As with the timeline view, the data manager may update the entries for each field associated with a particular program in response to receiving an update to the program. Additionally, the data manager may remove the correspondence of the selected program to the field in response to receiving an edit to one of the entries for the field.

In an embodiment, model and field data is stored in model and field data repository 160. Model data comprises data models created for one or more fields. For example, a crop model may include a digitally constructed model of the development of a crop on the one or more fields. “Model,” in this context, refers to an electronic digitally stored set of executable instructions and data values, associated with one another, which are capable of receiving and responding to a programmatic or other digital call, invocation, or request for resolution based upon specified input values, to yield one or more stored or calculated output values that can serve as the basis of computer-implemented recommendations, output data displays, or machine control, among other things. Persons of skill in the field find it convenient to express models using mathematical equations, but that form of expression does not confine the models disclosed herein to abstract concepts; instead, each model herein has a practical application in a computer in the form of stored executable instructions and data that implement the model using the computer. The model may include a model of past events on the one or more fields, a model of the current status of the one or more fields, and/or a model of predicted events on the one or more fields. Model and field data may be stored in data structures in memory, rows in a database table, in flat files or spreadsheets, or other forms of stored digital data.

In an embodiment, agricultural intelligence computer system 130 is programmed to comprise an agricultural data management server computer (server) 170. The server 170 is further configured to comprise soil data collection instructions 172, soil moisture estimation instructions module 174, yield prediction and seeding rate determination instructions 176, yield risk determination instructions 178, and yield risk presentation instructions 180.

The soil data collection instructions 172 offer computer-executable instruction to collect different types of soil data for a plurality of subfields of one or more fields for a plurality of sub-periods of a period, such as a period of 10 years. The soil data can be soil chemistry data, soil topology data, field imagery data, or soil moisture data. The soil moisture data may be available at a higher frequency, such as on a monthly basis. For training the yield prediction model, the soil data generally also includes the seeding rates and the corresponding yields. The different types of soil data may be received from grower devices, public data sources, field probes, or cameras on aerial devices.

The soil moisture estimation instructions 174 offer computer-executable instructions to analyze the soil moisture data to build a soil moisture prediction model. The soil moisture data generally includes observed soil moisture for some of the plurality of subfields, which can be used to estimate soil moisture for the other subfields based on spatial correlations. The soil moisture prediction model can further consider temporal correlations in the soil moisture data. The soil moisture estimation instructions 174 also offer computer-executable instructions to execute the soil moisture prediction model and produce additional soil moisture data.

The yield prediction and seeding rate determination instructions 176 offer computer-executable instructions to build a yield prediction model from the soil moisture data. The yield prediction can also be trained on additional data, such as the soil chemistry data, the soil topology data, the field imagery data, the seeding rate data, the fertilizer data, or the seed genetics data. The yield prediction and seeding rate determination instructions 176 also offer computer-executable instructions to execute the yield prediction model. Certain seeding rates can be fed to the yield prediction model to determine the optimal seeding rate corresponding to the highest estimated yield.

The yield risk determination instructions 178 offer computer-executable instructions to determine the risk associated with an estimated yield given historical yield data. The risk determination instructions 178 may work in conjunction with the other instructions within the server 170 to simulate some of the historical yield data.

The yield risk presentation instructions 180 offer computer-executable instructions to present data related to the risk values produced by executing the other instructions within the server 170. Such data may include the estimated soil moisture amounts, predicted yields, recommended seeding rates to achieve the predicted yields, or risks associated with the predicted yields. The analysis results can be transmitted directly to appropriate destinations, such as grower devices, or through graphical user interfaces. Specifically, computer-executable instructions cause generation of a graphical user interface that allows a user to see how varying projected risks may result in different predicted yields.

Each component of the server 170 comprises a set of one or more pages of main memory, such as RAM, in the agricultural intelligence computer system 130 into which executable instructions have been loaded and which when executed cause the agricultural intelligence computing system to perform the functions or operations that are described herein with reference to those modules. For example, the soil data collection module 172 may comprise a set of pages in RAM that contain instructions which when executed cause performing the location selection functions that are described herein. The instructions may be in machine executable code in the instruction set of a CPU and may have been compiled based upon source code written in JAVA, C, C++, OBJECTIVE-C, or any other human-readable programming language or environment, alone or in combination with scripts in JAVASCRIPT, other scripting languages and other programming source text. The term “pages” is intended to refer broadly to any region within main memory and the specific terminology used in a system may vary depending on the memory architecture or processor architecture. In another embodiment, each component of the server 170 also may represent one or more files or projects of source code that are digitally stored in a mass storage device such as non-volatile RAM or disk storage, in the agricultural intelligence computer system 130 or a separate repository system, which when compiled or interpreted cause generating executable instructions which when executed cause the agricultural intelligence computing system to perform the functions or operations that are described herein with reference to those modules. In other words, the drawing figure may represent the manner in which programmers or software developers organize and arrange source code for later compilation into an executable, or interpretation into bytecode or the equivalent, for execution by the agricultural intelligence computer system 130.

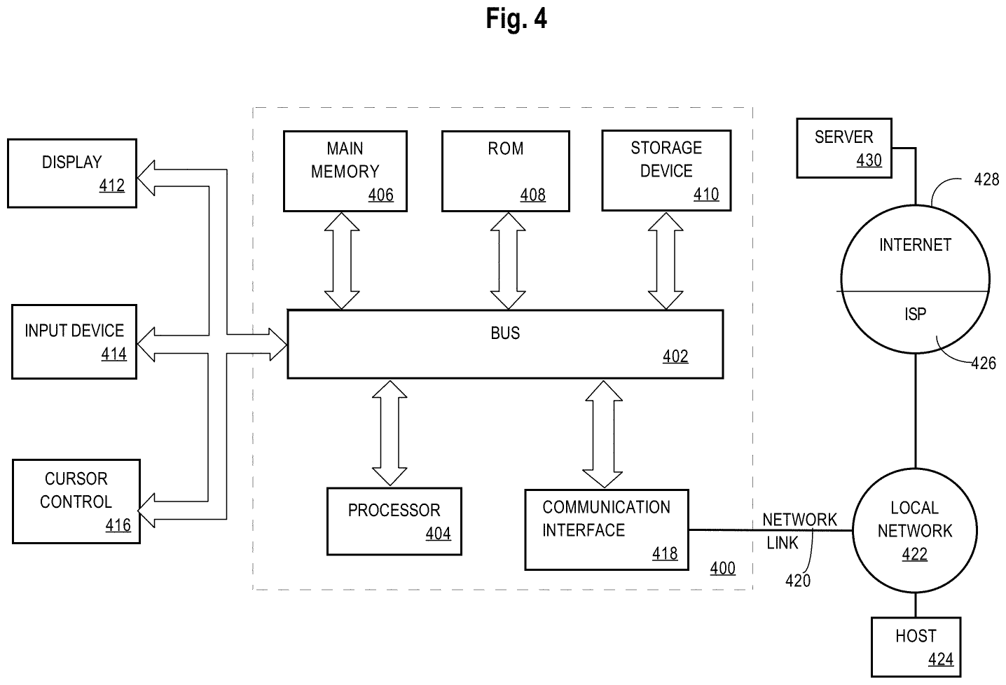

Hardware/virtualization layer 150 comprises one or more central processing units (CPUs), memory controllers, and other devices, components, or elements of a computer system such as volatile or non-volatile memory, non-volatile storage such as disk, and I/O devices or interfaces as illustrated and described, for example, in connection with FIG. 4. The layer 150 also may comprise programmed instructions that are configured to support virtualization, containerization, or other technologies.

For purposes of illustrating a clear example, FIG. 1 shows a limited number of instances of certain functional elements. However, in other embodiments, there may be any number of such elements. For example, embodiments may use thousands or millions of different mobile computing devices 104 associated with different users. Further, the system 130 and/or external data server computer 108 may be implemented using two or more processors, cores, clusters, or instances of physical machines or virtual machines, configured in a discrete location or co-located with other elements in a datacenter, shared computing facility or cloud computing facility.

2.2. Application Program Overview

In an embodiment, the implementation of the functions described herein using one or more computer programs or other software elements that are loaded into and executed using one or more general-purpose computers will cause the general-purpose computers to be configured as a particular machine or as a computer that is specially adapted to perform the functions described herein. Further, each of the flow diagrams that are described further herein may serve, alone or in combination with the descriptions of processes and functions in prose herein, as algorithms, plans or directions that may be used to program a computer or logic to implement the functions that are described. In other words, all the prose text herein, and all the drawing figures, together are intended to provide disclosure of algorithms, plans or directions that are sufficient to permit a skilled person to program a computer to perform the functions that are described herein, in combination with the skill and knowledge of such a person given the level of skill that is appropriate for inventions and disclosures of this type.

In an embodiment, user 102 interacts with agricultural intelligence computer system 130 using field manager computing device 104 configured with an operating system and one or more application programs or apps; the field manager computing device 104 also may interoperate with the agricultural intelligence computer system independently and automatically under program control or logical control and direct user interaction is not always required. Field manager computing device 104 broadly represents one or more of a smart phone, PDA, tablet computing device, laptop computer, desktop computer, workstation, or any other computing device capable of transmitting and receiving information and performing the functions described herein. Field manager computing device 104 may communicate via a network using a mobile application stored on field manager computing device 104, and in some embodiments, the device may be coupled using a cable 113 or connector to the sensor 112 and/or controller 114. A particular user 102 may own, operate or possess and use, in connection with system 130, more than one field manager computing device 104 at a time.

The mobile application may provide client-side functionality, via the network to one or more mobile computing devices. In an example embodiment, field manager computing device 104 may access the mobile application via a web browser or a local client application or app. Field manager computing device 104 may transmit data to, and receive data from, one or more front-end servers, using web-based protocols or formats such as HTTP, XML and/or JSON, or app-specific protocols. In an example embodiment, the data may take the form of requests and user information input, such as field data, into the mobile computing device. In some embodiments, the mobile application interacts with location tracking hardware and software on field manager computing device 104 which determines the location of field manager computing device 104 using standard tracking techniques such as multilateration of radio signals, the global positioning system (GPS), WiFi positioning systems, or other methods of mobile positioning. In some cases, location data or other data associated with the device 104, user 102, and/or user account(s) may be obtained by queries to an operating system of the device or by requesting an app on the device to obtain data from the operating system.

In an embodiment, field manager computing device 104 sends field data 106 to agricultural intelligence computer system 130 comprising or including, but not limited to, data values representing one or more of: a geographical location of the one or more fields, tillage information for the one or more fields, crops planted in the one or more fields, and soil data extracted from the one or more fields. Field manager computing device 104 may send field data 106 in response to user input from user 102 specifying the data values for the one or more fields. Additionally, field manager computing device 104 may automatically send field data 106 when one or more of the data values becomes available to field manager computing device 104. For example, field manager computing device 104 may be communicatively coupled to remote sensor 112 and/or application controller 114 which include an irrigation sensor and/or irrigation controller. In response to receiving data indicating that application controller 114 released water onto the one or more fields, field manager computing device 104 may send field data 106 to agricultural intelligence computer system 130 indicating that water was released on the one or more fields. Field data 106 identified in this disclosure may be input and communicated using electronic digital data that is communicated between computing devices using parameterized URLs over HTTP, or another suitable communication or messaging protocol.

A commercial example of the mobile application is CLIMATE FIELDVIEW, commercially available from The Climate Corporation, San Francisco, Calif. The CLIMATE FIELDVIEW application, or other applications, may be modified, extended, or adapted to include features, functions, and programming that have not been disclosed earlier than the filing date of this disclosure. In one embodiment, the mobile application comprises an integrated software platform that allows a grower to make fact-based decisions for their operation because it combines historical data about the grower's fields with any other data that the grower wishes to compare. The combinations and comparisons may be performed in real time and are based upon scientific models that provide potential scenarios to permit the grower to make better, more informed decisions.

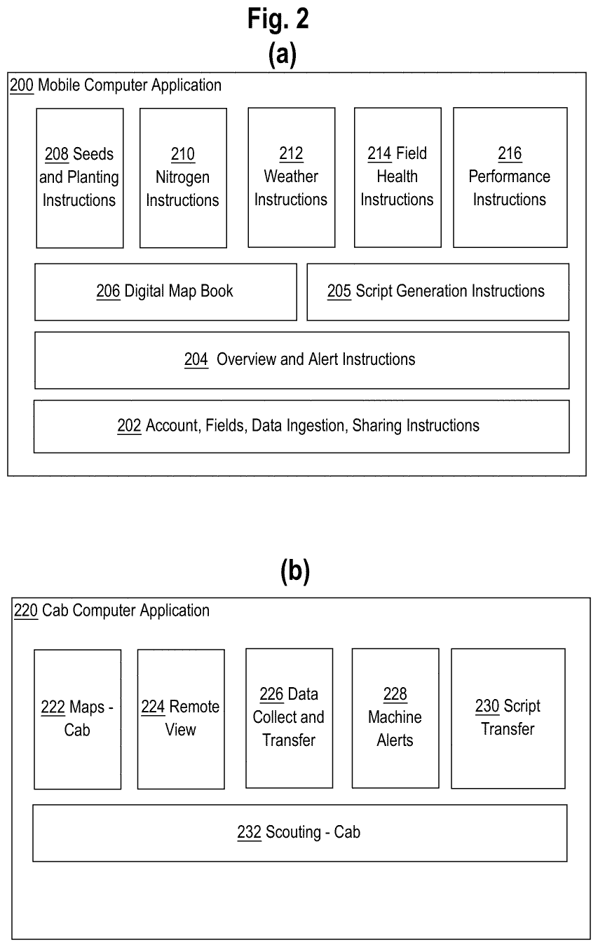

FIG. 2 illustrates two views of an example logical organization of sets of instructions in main memory when an example mobile application is loaded for execution. In FIG. 2, each named element represents a region of one or more pages of RAM or other main memory, or one or more blocks of disk storage or other non-volatile storage, and the programmed instructions within those regions. In one embodiment, in view (a), a mobile computer application 200 comprises account-fields-data ingestion-sharing instructions 202, overview and alert instructions 204, digital map book instructions 206, seeds and planting instructions 208, nitrogen instructions 210, weather instructions 212, field health instructions 214, and performance instructions 216.

In one embodiment, a mobile computer application 200 comprises account, fields, data ingestion, sharing instructions 202 which are programmed to receive, translate, and ingest field data from third party systems via manual upload or APIs. Data types may include field boundaries, yield maps, as-planted maps, soil test results, as-applied maps, and/or management zones, among others. Data formats may include shape files, native data formats of third parties, and/or farm management information system (FMIS) exports, among others. Receiving data may occur via manual upload, e-mail with attachment, external APIs that push data to the mobile application, or instructions that call APIs of external systems to pull data into the mobile application. In one embodiment, mobile computer application 200 comprises a data inbox. In response to receiving a selection of the data inbox, the mobile computer application 200 may display a graphical user interface for manually uploading data files and importing uploaded files to a data manager.

In one embodiment, digital map book instructions 206 comprise field map data layers stored in device memory and are programmed with data visualization tools and geospatial field notes. This provides growers with convenient information close at hand for reference, logging and visual insights into field performance. In one embodiment, overview and alert instructions 204 are programmed to provide an operation-wide view of what is important to the grower, and timely recommendations to take action or focus on particular issues. This permits the grower to focus time on what needs attention, to save time and preserve yield throughout the season. In one embodiment, seeds and planting instructions 208 are programmed to provide tools for seed selection, hybrid placement, and script creation, including variable rate (VR) script creation, based upon scientific models and empirical data. This enables growers to maximize yield or return on investment through optimized seed purchase, placement and population.

In one embodiment, script generation instructions 205 are programmed to provide an interface for generating scripts, including variable rate (VR) fertility scripts. The interface enables growers to create scripts for field implements, such as nutrient applications, planting, and irrigation. For example, a planting script interface may comprise tools for identifying a type of seed for planting. Upon receiving a selection of the seed type, mobile computer application 200 may display one or more fields broken into management zones, such as the field map data layers created as part of digital map book instructions 206. In one embodiment, the management zones comprise soil zones along with a panel identifying each soil zone and a soil name, texture, drainage for each zone, or other field data. Mobile computer application 200 may also display tools for editing or creating such, such as graphical tools for drawing management zones, such as soil zones, over a map of one or more fields. Planting procedures may be applied to all management zones or different planting procedures may be applied to different subsets of management zones. When a script is created, mobile computer application 200 may make the script available for download in a format readable by an application controller, such as an archived or compressed format. Additionally, and/or alternatively, a script may be sent directly to cab computer 115 from mobile computer application 200 and/or uploaded to one or more data servers and stored for further use.

In one embodiment, nitrogen instructions 210 are programmed to provide tools to inform nitrogen decisions by visualizing the availability of nitrogen to crops. This enables growers to maximize yield or return on investment through optimized nitrogen application during the season. Example programmed functions include displaying images such as SSURGO images to enable drawing of fertilizer application zones and/or images generated from subfield soil data, such as data obtained from sensors, at a high spatial resolution (as fine as millimeters or smaller depending on sensor proximity and resolution); upload of existing grower-defined zones; providing a graph of plant nutrient availability and/or a map to enable tuning application(s) of nitrogen across multiple zones; output of scripts to drive machinery; tools for mass data entry and adjustment; and/or maps for data visualization, among others. “Mass data entry,” in this context, may mean entering data once and then applying the same data to multiple fields and/or zones that have been defined in the system; example data may include nitrogen application data that is the same for many fields and/or zones of the same grower, but such mass data entry applies to the entry of any type of field data into the mobile computer application 200. For example, nitrogen instructions 210 may be programmed to accept definitions of nitrogen application and practices programs and to accept user input specifying to apply those programs across multiple fields. “Nitrogen application programs,” in this context, refers to stored, named sets of data that associates: a name, color code or other identifier, one or more dates of application, types of material or product for each of the dates and amounts, method of application or incorporation such as injected or broadcast, and/or amounts or rates of application for each of the dates, crop or hybrid that is the subject of the application, among others. “Nitrogen practices programs,” in this context, refer to stored, named sets of data that associates: a practices name; a previous crop; a tillage system; a date of primarily tillage; one or more previous tillage systems that were used; one or more indicators of application type, such as manure, that were used. Nitrogen instructions 210 also may be programmed to generate and cause displaying a nitrogen graph, which indicates projections of plant use of the specified nitrogen and whether a surplus or shortfall is predicted; in some embodiments, different color indicators may signal a magnitude of surplus or magnitude of shortfall. In one embodiment, a nitrogen graph comprises a graphical display in a computer display device comprising a plurality of rows, each row associated with and identifying a field; data specifying what crop is planted in the field, the field size, the field location, and a graphic representation of the field perimeter; in each row, a timeline by month with graphic indicators specifying each nitrogen application and amount at points correlated to month names; and numeric and/or colored indicators of surplus or shortfall, in which color indicates magnitude.

In one embodiment, the nitrogen graph may include one or more user input features, such as dials or slider bars, to dynamically change the nitrogen planting and practices programs so that a user may optimize his nitrogen graph. The user may then use his optimized nitrogen graph and the related nitrogen planting and practices programs to implement one or more scripts, including variable rate (VR) fertility scripts. Nitrogen instructions 210 also may be programmed to generate and cause displaying a nitrogen map, which indicates projections of plant use of the specified nitrogen and whether a surplus or shortfall is predicted; in some embodiments, different color indicators may signal a magnitude of surplus or magnitude of shortfall. The nitrogen map may display projections of plant use of the specified nitrogen and whether a surplus or shortfall is predicted for different times in the past and the future (such as daily, weekly, monthly or yearly) using numeric and/or colored indicators of surplus or shortfall, in which color indicates magnitude. In one embodiment, the nitrogen map may include one or more user input features, such as dials or slider bars, to dynamically change the nitrogen planting and practices programs so that a user may optimize his nitrogen map, such as to obtain a preferred amount of surplus to shortfall. The user may then use his optimized nitrogen map and the related nitrogen planting and practices programs to implement one or more scripts, including variable rate (VR) fertility scripts. In other embodiments, similar instructions to the nitrogen instructions 210 could be used for application of other nutrients (such as phosphorus and potassium), application of pesticide, and irrigation programs.

In one embodiment, weather instructions 212 are programmed to provide field-specific recent weather data and forecasted weather information. This enables growers to save time and have an efficient integrated display with respect to daily operational decisions.

In one embodiment, field health instructions 214 are programmed to provide timely remote sensing images highlighting in-season crop variation and potential concerns. Example programmed functions include cloud checking, to identify possible clouds or cloud shadows; determining nitrogen indices based on field images; graphical visualization of scouting layers, including, for example, those related to field health, and viewing and/or sharing of scouting notes; and/or downloading satellite images from multiple sources and prioritizing the images for the grower, among others.

In one embodiment, performance instructions 216 are programmed to provide reports, analysis, and insight tools using on-farm data for evaluation, insights and decisions. This enables the grower to seek improved outcomes for the next year through fact-based conclusions about why return on investment was at prior levels, and insight into yield-limiting factors. The performance instructions 216 may be programmed to communicate via the network(s) 109 to back-end analytics programs executed at agricultural intelligence computer system 130 and/or external data server computer 108 and configured to analyze metrics such as yield, yield differential, hybrid, population, SSURGO zone, soil test properties, or elevation, among others. Programmed reports and analysis may include yield variability analysis, treatment effect estimation, benchmarking of yield and other metrics against other growers based on anonymized data collected from many growers, or data for seeds and planting, among others.

Applications having instructions configured in this way may be implemented for different computing device platforms while retaining the same general user interface appearance. For example, the mobile application may be programmed for execution on tablets, smartphones, or server computers that are accessed using browsers at client computers. Further, the mobile application as configured for tablet computers or smartphones may provide a full app experience or a cab app experience that is suitable for the display and processing capabilities of cab computer 115. For example, referring now to view (b) of FIG. 2, in one embodiment a cab computer application 220 may comprise maps-cab instructions 222, remote view instructions 224, data collect and transfer instructions 226, machine alerts instructions 228, script transfer instructions 230, and scouting-cab instructions 232. The code base for the instructions of view (b) may be the same as for view (a) and executables implementing the code may be programmed to detect the type of platform on which they are executing and to expose, through a graphical user interface, only those functions that are appropriate to a cab platform or full platform. This approach enables the system to recognize the distinctly different user experience that is appropriate for an in-cab environment and the different technology environment of the cab. The maps-cab instructions 222 may be programmed to provide map views of fields, farms or regions that are useful in directing machine operation. The remote view instructions 224 may be programmed to turn on, manage, and provide views of machine activity in real-time or near real-time to other computing devices connected to the system 130 via wireless networks, wired connectors or adapters, and the like. The data collect and transfer instructions 226 may be programmed to turn on, manage, and provide transfer of data collected at sensors and controllers to the system 130 via wireless networks, wired connectors or adapters, and the like. The machine alerts instructions 228 may be programmed to detect issues with operations of the machine or tools that are associated with the cab and generate operator alerts. The script transfer instructions 230 may be configured to transfer in scripts of instructions that are configured to direct machine operations or the collection of data. The scouting-cab instructions 232 may be programmed to display location-based alerts and information received from the system 130 based on the location of the field manager computing device 104, agricultural apparatus 111, or sensors 112 in the field and ingest, manage, and provide transfer of location-based scouting observations to the system 130 based on the location of the agricultural apparatus 111 or sensors 112 in the field.

2.3. Data Ingest to the Computer System

In an embodiment, external data server computer 108 stores external data 110, including soil data representing soil composition for the one or more fields and weather data representing temperature and precipitation on the one or more fields. The weather data may include past and present weather data as well as forecasts for future weather data. In an embodiment, external data server computer 108 comprises a plurality of servers hosted by different entities. For example, a first server may contain soil composition data while a second server may include weather data. Additionally, soil composition data may be stored in multiple servers. For example, one server may store data representing percentage of sand, silt, and clay in the soil while a second server may store data representing percentage of organic matter (OM) in the soil.

In an embodiment, remote sensor 112 comprises one or more sensors that are programmed or configured to produce one or more observations. Remote sensor 112 may be aerial sensors, such as satellites, vehicle sensors, planting equipment sensors, tillage sensors, fertilizer or insecticide application sensors, harvester sensors, and any other implement capable of receiving data from the one or more fields. In an embodiment, application controller 114 is programmed or configured to receive instructions from agricultural intelligence computer system 130. Application controller 114 may also be programmed or configured to control an operating parameter of an agricultural vehicle or implement. For example, an application controller may be programmed or configured to control an operating parameter of a vehicle, such as a tractor, planting equipment, tillage equipment, fertilizer or insecticide equipment, harvester equipment, or other farm implements such as a water valve. Other embodiments may use any combination of sensors and controllers, of which the following are merely selected examples.

The system 130 may obtain or ingest data under user 102 control, on a mass basis from a large number of growers who have contributed data to a shared database system. This form of obtaining data may be termed “manual data ingest” as one or more user-controlled computer operations are requested or triggered to obtain data for use by the system 130. As an example, the CLIMATE FIELDVIEW application, commercially available from The Climate Corporation, San Francisco, Calif., may be operated to export data to system 130 for storing in the repository 160.

For example, seed monitor systems can both control planter apparatus components and obtain planting data, including signals from seed sensors via a signal harness that comprises a CAN backbone and point-to-point connections for registration and/or diagnostics. Seed monitor systems can be programmed or configured to display seed spacing, population and other information to the user via the cab computer 115 or other devices within the system 130. Examples are disclosed in U.S. Pat. No. 8,738,243 and US Pat. Pub. 20150094916, and the present disclosure assumes knowledge of those other patent disclosures.

Likewise, yield monitor systems may contain yield sensors for harvester apparatus that send yield measurement data to the cab computer 115 or other devices within the system 130. Yield monitor systems may utilize one or more remote sensors 112 to obtain grain moisture measurements in a combine or other harvester and transmit these measurements to the user via the cab computer 115 or other devices within the system 130.

In an embodiment, examples of sensors 112 that may be used with any moving vehicle or apparatus of the type described elsewhere herein include kinematic sensors and position sensors. Kinematic sensors may comprise any of speed sensors such as radar or wheel speed sensors, accelerometers, or gyros. Position sensors may comprise GPS receivers or transceivers, or WiFi-based position or mapping apps that are programmed to determine location based upon nearby WiFi hotspots, among others.

In an embodiment, examples of sensors 112 that may be used with tractors or other moving vehicles include engine speed sensors, fuel consumption sensors, area counters or distance counters that interact with GPS or radar signals, PTO (power take-off) speed sensors, tractor hydraulics sensors configured to detect hydraulics parameters such as pressure or flow, and/or and hydraulic pump speed, wheel speed sensors or wheel slippage sensors. In an embodiment, examples of controllers 114 that may be used with tractors include hydraulic directional controllers, pressure controllers, and/or flow controllers; hydraulic pump speed controllers; speed controllers or governors; hitch position controllers; or wheel position controllers provide automatic steering.

In an embodiment, examples of sensors 112 that may be used with seed planting equipment such as planters, drills, or air seeders include seed sensors, which may be optical, electromagnetic, or impact sensors; downforce sensors such as load pins, load cells, pressure sensors; soil property sensors such as reflectivity sensors, moisture sensors, electrical conductivity sensors, optical residue sensors, or temperature sensors; component operating criteria sensors such as planting depth sensors, downforce cylinder pressure sensors, seed disc speed sensors, seed drive motor encoders, seed conveyor system speed sensors, or vacuum level sensors; or pesticide application sensors such as optical or other electromagnetic sensors, or impact sensors. In an embodiment, examples of controllers 114 that may be used with such seed planting equipment include: toolbar fold controllers, such as controllers for valves associated with hydraulic cylinders; downforce controllers, such as controllers for valves associated with pneumatic cylinders, airbags, or hydraulic cylinders, and programmed for applying downforce to individual row units or an entire planter frame; planting depth controllers, such as linear actuators; metering controllers, such as electric seed meter drive motors, hydraulic seed meter drive motors, or swath control clutches; hybrid selection controllers, such as seed meter drive motors, or other actuators programmed for selectively allowing or preventing seed or an air-seed mixture from delivering seed to or from seed meters or central bulk hoppers; metering controllers, such as electric seed meter drive motors, or hydraulic seed meter drive motors; seed conveyor system controllers, such as controllers for a belt seed delivery conveyor motor; marker controllers, such as a controller for a pneumatic or hydraulic actuator; or pesticide application rate controllers, such as metering drive controllers, orifice size or position controllers.

In an embodiment, examples of sensors 112 that may be used with tillage equipment include position sensors for tools such as shanks or discs; tool position sensors for such tools that are configured to detect depth, gang angle, or lateral spacing; downforce sensors; or draft force sensors. In an embodiment, examples of controllers 114 that may be used with tillage equipment include downforce controllers or tool position controllers, such as controllers configured to control tool depth, gang angle, or lateral spacing.

In an embodiment, examples of sensors 112 that may be used in relation to apparatus for applying fertilizer, insecticide, fungicide and the like, such as on-planter starter fertilizer systems, subsoil fertilizer applicators, or fertilizer sprayers, include: fluid system criteria sensors, such as flow sensors or pressure sensors; sensors indicating which spray head valves or fluid line valves are open; sensors associated with tanks, such as fill level sensors; sectional or system-wide supply line sensors, or row-specific supply line sensors; or kinematic sensors such as accelerometers disposed on sprayer booms. In an embodiment, examples of controllers 114 that may be used with such apparatus include pump speed controllers; valve controllers that are programmed to control pressure, flow, direction, PWM and the like; or position actuators, such as for boom height, subsoiler depth, or boom position.

In an embodiment, examples of sensors 112 that may be used with harvesters include yield monitors, such as impact plate strain gauges or position sensors, capacitive flow sensors, load sensors, weight sensors, or torque sensors associated with elevators or augers, or optical or other electromagnetic grain height sensors; grain moisture sensors, such as capacitive sensors; grain loss sensors, including impact, optical, or capacitive sensors; header operating criteria sensors such as header height, header type, deck plate gap, feeder speed, and reel speed sensors; separator operating criteria sensors, such as concave clearance, rotor speed, shoe clearance, or chaffer clearance sensors; auger sensors for position, operation, or speed; or engine speed sensors. In an embodiment, examples of controllers 114 that may be used with harvesters include header operating criteria controllers for elements such as header height, header type, deck plate gap, feeder speed, or reel speed; separator operating criteria controllers for features such as concave clearance, rotor speed, shoe clearance, or chaffer clearance; or controllers for auger position, operation, or speed.

In an embodiment, examples of sensors 112 that may be used with grain carts include weight sensors, or sensors for auger position, operation, or speed. In an embodiment, examples of controllers 114 that may be used with grain carts include controllers for auger position, operation, or speed.

In an embodiment, examples of sensors 112 and controllers 114 may be installed in unmanned aerial vehicle (UAV) apparatus or “drones.” Such sensors may include cameras with detectors effective for any range of the electromagnetic spectrum including visible light, infrared, ultraviolet, near-infrared (NIR), and the like; accelerometers; altimeters; temperature sensors; humidity sensors; pitot tube sensors or other airspeed or wind velocity sensors; battery life sensors; or radar emitters and reflected radar energy detection apparatus; other electromagnetic radiation emitters and reflected electromagnetic radiation detection apparatus. Such controllers may include guidance or motor control apparatus, control surface controllers, camera controllers, or controllers programmed to turn on, operate, obtain data from, manage and configure any of the foregoing sensors. Examples are disclosed in U.S. patent application Ser. No. 14/831,165 and the present disclosure assumes knowledge of that other patent disclosure.

In an embodiment, sensors 112 and controllers 114 may be affixed to soil sampling and measurement apparatus that is configured or programmed to sample soil and perform soil chemistry tests, soil moisture tests, and other tests pertaining to soil. For example, the apparatus disclosed in U.S. Pat. Nos. 8,767,194 and 8,712,148 may be used, and the present disclosure assumes knowledge of those patent disclosures.

In an embodiment, sensors 112 and controllers 114 may comprise weather devices for monitoring weather conditions of fields. For example, the apparatus disclosed in U.S. Provisional Application No. 62/154,207, filed on Apr. 29, 2015, U.S. Provisional Application No. 62/175,160, filed on Jun. 12, 2015, U.S. Provisional Application No. 62/198,060, filed on Jul. 28, 2015, and U.S. Provisional Application No. 62/220,852, filed on Sep. 18, 2015, may be used, and the present disclosure assumes knowledge of those patent disclosures.

2.4. Process Overview-Agronomic Model Training

In an embodiment, the agricultural intelligence computer system 130 is programmed or configured to create an agronomic model. In this context, an agronomic model is a data structure in memory of the agricultural intelligence computer system 130 that comprises field data 106, such as identification data and harvest data for one or more fields. The agronomic model may also comprise calculated agronomic properties which describe either conditions which may affect the growth of one or more crops on a field, or properties of the one or more crops, or both. Additionally, an agronomic model may comprise recommendations based on agronomic factors such as crop recommendations, irrigation recommendations, planting recommendations, fertilizer recommendations, fungicide recommendations, pesticide recommendations, harvesting recommendations and other crop management recommendations. The agronomic factors may also be used to estimate one or more crop related results, such as agronomic yield. The agronomic yield of a crop is an estimate of quantity of the crop that is produced, or in some examples the revenue or profit obtained from the produced crop.

In an embodiment, the agricultural intelligence computer system 130 may use a preconfigured agronomic model to calculate agronomic properties related to currently received location and crop information for one or more fields. The preconfigured agronomic model is based upon previously processed field data, including but not limited to, identification data, harvest data, fertilizer data, and weather data. The preconfigured agronomic model may have been cross validated to ensure accuracy of the model. Cross validation may include comparison to ground truthing that compares predicted results with actual results on a field, such as a comparison of precipitation estimate with a rain gauge or sensor providing weather data at the same or nearby location or an estimate of nitrogen content with a soil sample measurement.

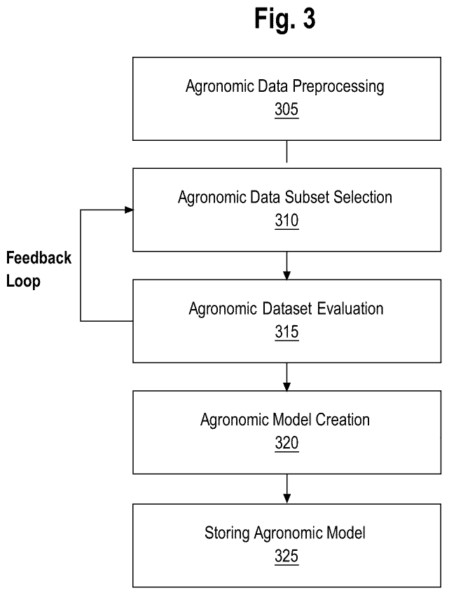

FIG. 3 illustrates a programmed process by which the agricultural intelligence computer system generates one or more preconfigured agronomic models using field data provided by one or more data sources. FIG. 3 may serve as an algorithm or instructions for programming the functional elements of the agricultural intelligence computer system 130 to perform the operations that are now described.

At block 305, the agricultural intelligence computer system 130 is configured or programmed to implement agronomic data preprocessing of field data received from one or more data sources. The field data received from one or more data sources may be preprocessed for the purpose of removing noise, distorting effects, and confounding factors within the agronomic data including measured outliers that could adversely affect received field data values. Embodiments of agronomic data preprocessing may include, but are not limited to, removing data values commonly associated with outlier data values, specific measured data points that are known to unnecessarily skew other data values, data smoothing, aggregation, or sampling techniques used to remove or reduce additive or multiplicative effects from noise, and other filtering or data derivation techniques used to provide clear distinctions between positive and negative data inputs.

At block 310, the agricultural intelligence computer system 130 is configured or programmed to perform data subset selection using the preprocessed field data in order to identify datasets useful for initial agronomic model generation. The agricultural intelligence computer system 130 may implement data subset selection techniques including, but not limited to, a genetic algorithm method, an all subset models method, a sequential search method, a stepwise regression method, a particle swarm optimization method, and an ant colony optimization method. For example, a genetic algorithm selection technique uses an adaptive heuristic search algorithm, based on evolutionary principles of natural selection and genetics, to determine and evaluate datasets within the preprocessed agronomic data.

At block 315, the agricultural intelligence computer system 130 is configured or programmed to implement field dataset evaluation. In an embodiment, a specific field dataset is evaluated by creating an agronomic model and using specific quality thresholds for the created agronomic model. Agronomic models may be compared and/or validated using one or more comparison techniques, such as, but not limited to, root mean square error with leave-one-out cross validation (RMSECV), mean absolute error, and mean percentage error. For example, RMSECV can cross validate agronomic models by comparing predicted agronomic property values created by the agronomic model against historical agronomic property values collected and analyzed. In an embodiment, the agronomic dataset evaluation logic is used as a feedback loop where agronomic datasets that do not meet configured quality thresholds are used during future data subset selection steps (block 310).

At block 320, the agricultural intelligence computer system 130 is configured or programmed to implement agronomic model creation based upon the cross validated agronomic datasets. In an embodiment, agronomic model creation may implement multivariate regression techniques to create preconfigured agronomic data models.

At block 325, the agricultural intelligence computer system 130 is configured or programmed to store the preconfigured agronomic data models for future field data evaluation.

2.5. Implementation Example-Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infrared data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infrared signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### 3. Functional Descriptions

3.1 Collecting Training Data of Soil Properties and Yields

In some embodiments, each field is divided into sub-fields. For examples, each sub-field can be 10 meters by 10 meters. The server 170 is programmed to receive or obtain different types of data regarding different subfields within specific fields at different points within a period for model training purposes. The different types of data may include soil chemistry data, such as data related to organic matter, cation exchange capacity, or pH scale. The different types of data may include soil topography data, such as elevation, slope, curvature, or aspect. The different types of data may further include imagery data, such as satellite images or other aerial images, which can indicate moisture, vegetation, disease state, or other soil properties of the specific fields and thus can be used to derive other types of data. In addition, the different types of data may include fertilizer data, such as nutrient type, or seed genetics data, such as germplasm (base genetics+trait), pedigree information, genetic cluster patterns, or genomic marker relationships. The period can be one or more years. The frequency of the different points may be hourly, daily, monthly, quarterly, or even less frequently for those types of data that do not vary much over time. These data may be received via manual entry by the user 102. These data may also be part of the field data 106 or the external data 110. In addition, these data may also be retrieved from the repository 160 if they have been previously collected for purposes of other applications.

In some embodiments, the server 170 is programmed to receive weather-related data regarding the different subfields at various points within the period. The frequency of the various points in this case may be higher than the frequency of the different points at which the other types of data is available. The weather data could include precipitation data and irrigation data for water into the soil or evapotranspiration data, drainage data, runoff data, or initial or minimum soil saturation data for water out of the soil. Weather data may be obtained, for example, as part of external data 110 from a third-party online weather information database or server, via a parameterized URL, API call or other programmatic mechanism.

The server 170 is programmed to further receive moisture data measured by moisture probes regarding some of the different subfields at the various points within the period. Moisture probe data may form part of the field data 106 or may be input by the user 102 using a programmed user interface. The availability of such moisture data is typically limited as the number of moisture probes that can be implemented is generally relatively small. The server 170 can be programmed to extend the scope of moisture information by predicting the moisture for those subfields where moisture probes are not implemented based on the moisture data that is available, as further discussed below.

In some embodiments, the server 170 is programmed to further receive soil density data, such as seeding rates, and yield data regarding the different subfields at the different points within the period. In other embodiments, the server 170 is programmed to fill in missing values of any of the soil properties covered in the received data by interpolation, extrapolation, clustering, or other techniques or by relying on user-provided default values.

3.2 Estimating Moisture Data

In some embodiments, the server 170 is programmed to predict soil moisture content for some subfields at the various points within the period. Given the precipitation data p and irrigation data irr, soil water dynamics can be defined via a dynamic spatio-temporal model (DSTM):

Yₜ(s)=wₜ(s)+eₜ(s) (1)

wₜ(s)=wₜ₋₁(s)+α(s)(p+irr)ₜ₋₁θ(s)(wₜ₋₁(s)−μ)+uₜ(s) (2)

where Yₜ(s) is observed soil moisture at time t for the subfield s typically by a moisture probe, wₜ(s) is actual soil moisture at time t in the subfield s, eₜ(s) is a random observation error, α(s) is the absorption rate, θ(s) is the drainage rate, μ (or μ(s)) is the minimum saturation data, and uₜ(s) is a spatially correlated error of the real, unobserved soil moisture. For a specific period within the period, given the Yₜ(s) values at specific points within the specific period for select subfields where soil moisture probes were available or soil moisture could otherwise be observed together with the values of p and irr at the specific points for the select subfields, the values of α(s), θ(s), and μ can be determined. Given the values of p and irr at the specific points for another subfield without observed soil moisture data, formula (2) can then be used to predict the actual soil moisture and the minimum saturation data for that subfield at the specific points given a value for wₜ(s) for at least one point in time. For example, the specific period can be a year or a growing season, and the specific points may correspond to individual days, weeks, or months.

3.3 Building a Yield Prediction Model

In some embodiments, the server 170 is programmed to build a yield prediction model for a subfield based on collected and estimated data. Initially, the server 170 can be programmed to convert the imagery data into certain image vectors that correspond to entire images or specific features of the images depending on the nature and resolution of the images.

In some embodiments, the server 170 is programmed to calculate moisture stress indicators (MSI) for each subfield from the soil moisture data. Each MSI can be defined as the percentage of the specific period that the soil moisture is in wet stress or in dry stress. The wet stress can be defined as the moisture value being above a certain wet threshold. The dry stress can be similarly defined as the moisture value being below a certain dry threshold. For example, the specific period can be a year, and the MSI can be the percentage of the year in terms of months or days when a subfield is in wet stress or dry stress. The wet threshold or dry threshold can be specific to each field having multiple subfields, reach region having multiple fields, or each weather type (e.g., in terms of annual rainfall or solar radiation), or they can be invariant across regions or weather types.

The server 107 can be configured to determine the wet threshold or dry threshold from historical data. For example, the wet threshold and the dry threshold can respectively be the 90% point and the 10% point of the range between the maximum and minimum daily or monthly moisture amount during the last 10 years. For further example, the wet threshold and the dry threshold can respectively be the points where yields deviate from an aggregate daily or monthly yield for a more than a certain amount.

In some embodiments, the server 170 is programmed to determine or improve predictions of ponding zones and drought zones for each subfield from the soil moisture data. For example, when soil moisture of a subfield meets or exceeds a high threshold on a majority of days throughout the growing season, the subfield can be considered as a ponding zone. Similarly, when the soil moisture of a subfield is below a low threshold on a majority of days throughout the growing season, the subfield can be considered as a drought zone. The server 170 can be programmed to predict yield and recommend optimal seeding rates based on the risk of ponding or drought, which may correspond to a confidence score associated with a prediction of a ponding zone or drought zone, for example.

In some embodiments, the server 170 can be configured to calculate additional features for each subfield from the soil moisture data, such as average moisture, moisture clusters, or moisture principal components.

In some embodiments, the server 170 is programmed to build a yield prediction model based on various features, such as values from the soil chemistry data, values from the soil topography data, values from the field imagery data, such as the image vectors, values from fertilizer data, such as “nitrogen” or “phosphorous”, values from seed genetics data, values or feature from the soil moisture data, such as the MSIs or risks of ponding or drought, and values from the soil density data, together with the yield data as the corresponding outcomes, for the subfields within the specific fields. The yield prediction model can be any discrete or statistical classification or regression model, such as a random forest, a clustering algorithm, a neural network, or a logistic regression classifier. For example, the apparatus disclosed in U.S. patent application Ser. No. 14/968,728, filed on Dec. 14, 2015, U.S. Provisional Application No. 62/750,153, filed on Oct. 24, 2018, U.S. Provisional Application No. 62/750,156, filed on Oct. 24, 2018, U.S. Provisional Application No. 62/784,276, filed on Dec. 21, 2018, and U.S. Provisional Application No. 62/832c148, filed on Apr. 10, 2019, may be used to incorporate fertilizer data, seed genetics data, field imagery data, or other related data, and the present disclosure assumes knowledge of those patent disclosures.

3.4 Collecting Soil Properties of Target Fields

In some embodiments, the server 170 is programmed to receive different types of soil data for subfields of certain fields at certain points within a certain period. The certain period is typically much longer than the specific period used in applying the DSTM, as discussed above, so that the DSTM and the yield prediction model can be applied repeatedly for a subfield for different sub-periods of the certain period to estimate the risk associated with the predicted yields for the subfield, as further discussed below. For example, the certain period can be 10 or 20 years.

In some embodiments, the different types of soil data may include the soil chemistry data, soil topography data, field imagery data, or the soil moisture data, as discussed above. The imagery data can be converted into image vectors, as discussed above. The measured moisture data for select subfields within the certain fields can be used to estimate the moisture data for the other subfields within the certain fields, as discussed above. In certain embodiments, the DTSM built from the training data can be used to estimate the moisture data for the other subfields within the certain fields. The moisture data can then be converted into MSIs, as discussed above. In other embodiments, missing values for subfields within the certain fields can be estimated, as discussed above.

3.5 Determining Optimal Seeding Rates and Corresponding Predicted Yields

In some embodiments, the server 170 is programmed to select a list of seeding rates for a subfield within the certain fields and execute the yield prediction model based on the most recent soil data and each of the list of seeding rates to obtain a predicted yield. The most recent soil data corresponds to an interval outside the certain period. The list of seeding rates can be identical across a number of subfields or can be subfield-specific based on the location, the crop to be planted, the historical planting patterns, or other factors. The server 170 is programmed to further identify one of the list of seeding rates, typically the optimal seeding rate corresponding to the highest predicted yield, for the subfield.

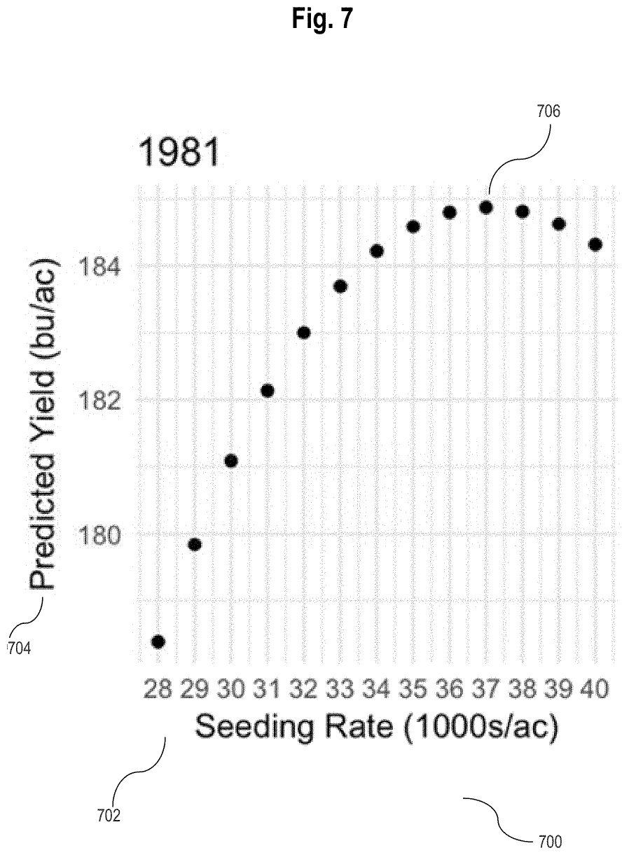

FIG. 7 illustrates an example relationship between seeding rates and predicted yields. The plot 700 has an X-axis 702 for seeding rates in units of 1K seeds per acre, and a Y-axis 704 for the corresponding predicted yields in units of bushels per acre. The list of seeding rates in this example is from 28K seeds per acre to 40K seeds per acre at increments of 1K. The corresponding predicted yields peak at the point 706 for a seeding rate of 37K seeds per acre and a corresponding predicted yield of approximately 185 bushels per acre. Therefore, with 185 bushels per acre being the highest predicted yield, the 37K seeds per acre is taken as the optimal seeding rate.

In some embodiments, the server 170 is programmed to adjust or smooth out the identified seeding rates across subfields, as it is generally undesirable or impossible to implement drastically different seeding rates in neighboring subfields. The server 170 can be configured to adjust the identified seeding rates by changing any identified seeding rate for a subfield that deviates from one or more of the identified seeding rates for the nearest subfields of the subfield for more than a threshold. Other smoothing techniques can be used, such as clustering the identified seeding rates and changing each identified seeding rate in its own cluster (or a cluster of a size below a certain threshold) to an aggregate identified seeding rate of a nearest cluster. The server 170 is programmed to further determine the predicted yield corresponding to any adjusted seeding rate. Such predicted yield is already available when the adjusted seeding rate is another one of the list of seeding rates, or the yield prediction model can be re-applied with the adjusted seeding rate to obtain the adjusted predicted yield.

3.6 Determining Risk Values Associated with Predicted Yields

In some embodiments, the server 170 is programmed to compute a risk value representing risk associated with the (adjusted if available or original) predicted yield based on historical data. Yields derived from soil moisture data and additional weather data might be used to estimate the risk of a predicted yield or the probability that the predicted yield does not occur due to unpredictable weather. More specifically, the server 170 is programmed to divide the certain period into sub-periods and execute the yield prediction model for each of the sub-periods. For example, the certain period could be 10 years, and each sub-period could be one year. For each subfield, the moisture data for each year can be measured by moisture probes or estimated from the measurements or satellite images for each month. For each of the sub-periods, the server 170 can be configured to repeat this procedure for all the subfields of the certain fields and adjust the identified seeding rates via a smoothing operation and obtain the adjusted yields, as discussed above.

In some embodiments, for each subfield, the server 170 is programmed to then construct a set of quantiles at set increments for the (adjusted if available or original) predicted yields over all the sub-periods, which corresponds to a risk profile associated with predicted yields. The predicted yields over the sub-periods can be weighted. For example, the predicted yields for more recent sub-periods can be weighted more as the moisture data for the more recent sub-periods might be more likely to be similar to the current moisture data. The server 170 is programmed to further identify in which quantile the predicted yield for the most recent interval is, with the most recent interval lying outside the certain period, and take that as the estimated risk associated with that predicted yield. For example, if the predicted yield for the most recent interval is in the 30% quantile, it would mean that in the past 10 years, about 30% of the predicted yields were less than the predicted yield for the most recent interval, and thus the risk associated with that predicted yield would be estimated as 30%.

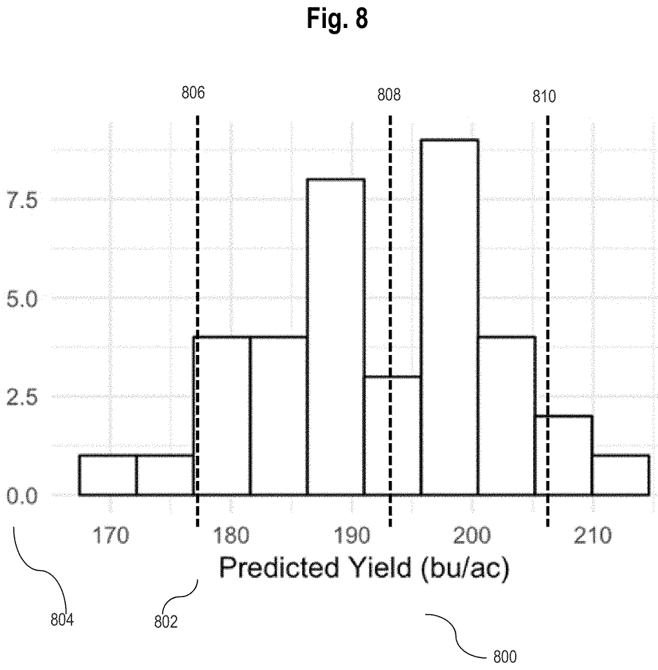

FIG. 8 illustrates an example distribution of yields forming quantiles. The plot 800 includes an X-axis for predicted yields in units of bushels per acre, and a Y-axis for counts. The plot 800 thus shows, for increasing predicted yields, how many times the predictions occur during the certain period. It can be seen along the line 806 that about 10% of the time the predicted yield falls below approximately 175 bushels per acre, along the line 808 that about 50% of the time the predicted yield falls below approximately 192 bushels per acre, and along the line 810 that about 90% of the time the predicted yield falls below approximately 206 bushels per acre. Therefore, by identifying in which quantile a predicted yield belongs, the quantile can be taken as an estimated risk associated with the predicted yield.

In some embodiments, the server 170 is programmed to present the (adjusted if available or original) predicted yields with associated risks, such as by transmitting or causing display of such data to remote devices associated with the subfields.

3.7 Generating Seeding Rate Prescriptions

In some embodiments, the server 170 is programmed to estimate the risk based on data aggregated over the sub-fields to the field level, assuming that the weather condition does not vary substantially across a field. More specifically, the server 170 is programmed to aggregate the (adjusted if available or original) predicted yields and the corresponding seeding rates over all the subfields for each sub-period of the certain period. Therefore, the aggregated predicted yields for the certain period can be weighted and tallied over the sub-fields to build an updated risk profile.

In some embodiments, the server 170 is programmed to determine a prescription of seeding rates based on this updated risk profile. The server 170 can be configured to preselect upper and lower bounds on the risk associated with a predicted yield or obtain such bounds as input. The server 170 can be configured to then identify the aggregated predicted yields in the quantiles in the updated risk profiles corresponding to the bounds and further identify the corresponding aggregated seeding rates, thereby providing a range of seeding rates as the prescription for growers or grower devices associated with the subfields. The lower and upper bounds can be constant or could depend on the predicted yield based on the most recent soil moisture data for a subfield. For example, the estimated risk for the predicted yield based on the most recent soil moisture data might be 30%. The lower and upper bounds can be set to a certain percentage below and above that estimated risk, such as from 25% to 35%, or from a specific percentage up to the estimated risk, such as from 10% to 30%.

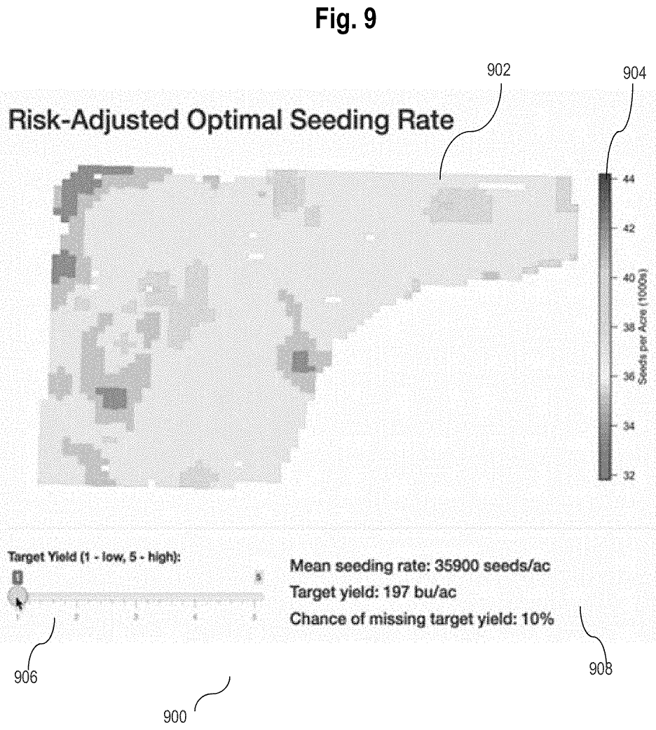

FIG. 9 illustrates an example computer-generated screen display of a graphical user interface related to a risk profile. This screen allows viewing how optimal seeding rate changes as the estimated risk changes across subfields based on the risk profile built from historical data. The screen 900 includes a field portion 902, a scale 904, a slider 906, and a statistics portion 908. The slider 906 is used to specify the estimated risk, from 1 corresponding 10%, 2 corresponding to 25%, 3 corresponding to 50%, 4 corresponding to 75%, and 5 corresponding to 90%, for example. The field portion 902 shows the optimal seeding rate corresponding to the predicted yield having the estimated risk specified via the slider 906 based on the risk profile. Each unit or pixel of the portion 902 may correspond to a sub-field or a field, as discussed above. The value of the pixel is expressed in terms of the scale 904 in units of 1K bushels per acre. The statistics portion 908 includes aggregate metrics corresponding to the selected estimated risk, such as the average optimal seeding rate, the corresponding average predicted yield, or the corresponding average costs of seeds (given the unit price of seeds) across the subfields covered in the field portion 902.

3.8 Example Processes

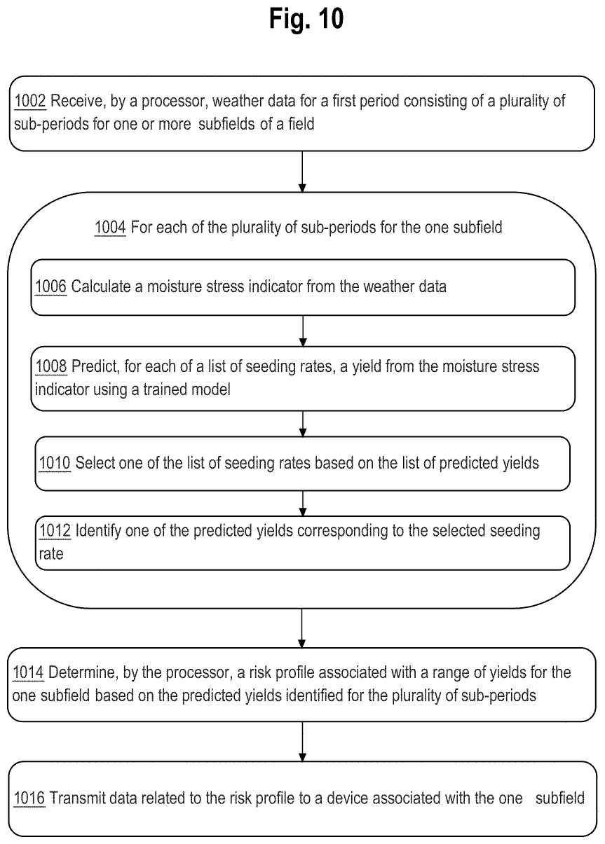

FIG. 10 illustrates an example method performed by a server computer that is programmed for predicting yields and recommending seeding rates for subfields with informed risks. FIG. 10 is intended to disclose an algorithm, plan or outline that can be used to implement one or more computer programs or other software elements which when executed cause performing the functional improvements and technical advances that are described herein. Furthermore, the flow diagrams herein are described at the same level of detail that persons of ordinary skill in the art ordinarily use to communicate with one another about algorithms, plans, or specifications forming a basis of software programs that they plan to code or implement using their accumulated skill and knowledge.

In some embodiments, in step 1002, the server is programmed or configured to receive weather data for a first period consisting of a plurality of sub-periods for one or more subfields of a field, as further described in section 3.1. Weather data may be obtained in the manner previously described in section 3.1, for example. The subfield can be 10 meters by 10 meters or have a similar size. The first period can be 10 years, while each sub-period can be one year. The weather data may include soil moisture data of probe measurements or estimated moisture amounts. In other embodiments, the server is programmed to receive additional soil data for the first period for the subfield, such as soil chemistry data, soil topology data, or field imagery data. At least some of the data can be collected from grower devices, public data sources, field probes, or cameras on aerial devices.

In some embodiments, in step 1004, the server is programmed or configured to take certain steps for each of the plurality of sub-periods for the one subfield, including steps 1006, 1008, 1010, and 1012. Thus, step 1004 represents executing programmatic iterations through steps 1006, 1008, 1010, and 1012, once or repeatedly, until all sub-periods associated with the one subfield have been processed.

In some embodiments, in step 1006, the server is programmed or configured to calculate a water stress indicator from the weather data. More specifically, the server is configured to transform some of the collected data into properties to be used in predicting the yield for the subfield, as further described in section 3.4. One transformation is to calculate the water stress indicator, which can be defined as the percentage of the sub-period that the soil moisture is in wet stress or in dry stress. For example, the sub-period may be one year, while the percentage can be expressed as the percentage of months or days in a year that the soil moisture is in wet stress or in dry stress. Another transformation is to extract features from the field imagery data.

In some embodiments, in step 1008, the server is programmed or configured to predict, for each of a list of seeding rates, a yield from the water stress indicator using a trained model, as further described in section 3.5. The model may have been trained on various soil properties, including the water stress indicator and the seeding rate, for a distinct field of subfields and a distinct period of sub-periods. The server is configured to apply the trained model to the water stress indicator calculated for the subfield and each of a list of seeding rates to obtain a list of predicted yields for the subfield.

In some embodiments, in step 1010, the server is programmed or configured to select one of the list of seeding rates based on the list of predicted yields, as further described in section 3.5. For example, the seeding rate corresponding to the highest predicted yield may be selected. In other embodiments, the server is configured to further obtain an adjusted seeding rate by considering the selected seeding rates for at least neighboring subfields. In step 1012, the server 170 is programmed or configured to further identify one of the predicted yields corresponding to the selected seeding rate or the adjusted seeding rate.

In some embodiments, in step 1014, the server is programmed or configured to determine a risk profile associated with a range of yields for the one subfield based on the predicted yields identified for the plurality of sub-periods or any available adjusted seeding rates, as further described in section 3.6. The server can be configured to build the risk profile using only the predicted yields for the subfield. Alternatively, the server can be configured to build the risk profile by aggregating the predicted yields (or adjusted predicted yields when available) over all the subfields of a field and the corresponding selected seeding rates (or adjusted selected seeding rates when available) over all the subfields of the field for each of the plurality of sub-periods. Furthermore, the server can be programmed to compute quantiles of the (aggregated) predicted yields as the risk profile associated with predicted yields.

In some embodiments, in step 1016, the server is programmed or configured to transmit data related to the risk profile to a device associated with the one subfield, as further described in sections 3.6 and 3.7. The data can be the risk profile itself. Alternatively, the data can be the seeding rates corresponding to the predicted yields that fall in certain quantiles, so that the device receives actionable items and information regarding predicted outcomes and associated risks.

### 4. Extensions and Alternatives

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-implemented method of predicting yields and recommending seeding rates for subfields with informed risks, comprising:
receiving, by a processor, weather data for a first period consisting of a plurality of sub-periods for one or more subfields of a field;
for each of the plurality of sub-periods for the one subfield:
calculating a moisture stress indicator from the weather data;
predicting, for each of a list of seeding rates, a yield from the moisture stress indicator using a trained model;
selecting one of the list of seeding rates based on the list of predicted yields; and
identifying one of the predicted yields corresponding to the selected seeding rate;
determining, by the processor, a risk profile associated with a range of yields for the one subfield based on the predicted yields identified for the plurality of sub-periods;
transmitting data related to the risk profile to a device associated with the one subfield.

2. The computer-implemented method of claim 1,
the weather data including observed soil moisture data for a certain subfield of the one or more subfields,
the calculating comprising estimating soil moisture data for a specific subfield of the one or more subfields from the weather data using a dynamic spatio-temporal model (DSTM).

3. The computer-implemented method of claim 2, the estimating comprising, solving, given precipitation data p, irrigation data irr, and observed soil moisture data for a subset of the one or more subfields, for α(s) and θ(s) and μ in:
Yₜ(s)=wₜ(s)+eₜ(s),
wₜ(s)=wₜ₋₁(s)+α(s)(p+irr)ₜ₋₁−θ(s)(wₜ₋₁(s)−μ)+uₜ(s),
Yₜ(s) being observed soil moisture at time t for the subfield s, wₜ(s) being an actual or estimated soil moisture at time t in a subfield s, μ being minimum saturation data, eₜ(s) being a random observation error, and uₜ(s) being a spatially correlated error of a real, unobserved soil moisture,
α(s) being an absorption rate and θ(s) being a water-out rate,
t corresponding to multiple points in an interval within the sub-period.

4. The computer-implemented method of claim 3, the estimating further comprising
computing, given precipitation data p, irrigation data irr, and wₜ(s) for at least one t of the specific subfield, soil moisture data for the specific subfield from:
wₜ(s)=wₜ₋₁(s)+α(s)(p+irr)ₜ₋₁−θ(s)(wₜ₋₁(s)−μ)+uₜ(s).

5. The computer-implemented method of claim 1, the calculating further comprising:
determining soil moisture for the sub-period for the specific subfield from the weather data;
computing the moisture stress indicator as a percentage of the sub-period when the soil moisture for the one subfield is above a wet threshold or below a dry threshold within the sub-period.

6. The computer-implemented method of claim 1, further comprising
receiving soil chemistry data, soil topology data, or field imagery data for the first period for the one or more subfields,
the predicting being performed further based on the soil chemistry data, the soil topology data, or the field imagery data.

7. The computer-implemented method of claim 6,
the soil chemistry data including data related to organic matter, cation exchange capacity, or pH scale,
the soil topology data including data related to elevation, slope, curvature, or aspect,
the field imagery data including satellite images or other aerial images.

8. The computer-implemented method of claim 1, further comprising
receiving training data for building the trained model,
the training data including, for each of a set of subfields for a certain period, soil moisture data, soil chemistry data, soil topology data, field imagery data, and soil seeding rate data at a point within the certain period and a corresponding yield.

9. The computer-implemented method of claim 1, the trained model being a random forest, a clustering algorithm, a neural network, or a logistic regression classifier.

10. The computer-implemented method of claim 1, the one seeding rate being an optimal seeding rate among the list of seeding rates corresponding to a highest predicted yield;

11. The computer-implemented method of claim 1, further comprising:
for each of the plurality of sub-periods for the one subfield:
adjusting the selected seeding rate to be closer to a selected or adjusted seeding rate for a neighboring subfield; and
determining an adjusted yield corresponding to the adjusted seeding rate,
the risk profile being determined based on the adjusted predicted yields for the plurality of subfields.

12. The computer-implemented method of claim 1, the determining further comprising:
computing quantiles of the plurality of predicted yields identified for the plurality of sub-periods,
the quantile where a predicted yield belongs indicating a risk associated with the predicted yield in the risk profile,
the risk being a percent chance that an actual yield is less than the predicted yield.

13. The computer-implemented method of claim 1, the determining further comprising:
for each of the plurality of sub-periods:
aggregating the plurality of identified predicted yields over the one or more subfields; and
aggregating the plurality of selected seeding rates over the one or more subfields;
computing quantiles of the plurality of aggregated predicted yields for the plurality of sub-periods,
the quantile where an aggregated predicted yield belongs indicating a risk associated with the aggregated predicted yield in the risk profile.

14. The computer-implemented method of claim 13, further comprising:
selecting a first aggregated predicted yield that belongs to a lower quantile and a second aggregated predicted yield that belongs to a higher quantile;
identifying a first aggregated seeding rate corresponding to the first aggregated predicted yield and a second aggregated seeding rate corresponding to the second aggregated predicted yield;
transmitting the first seeding rate with a lower risk associated with the first aggregated predicted yield and the second seeding rate with a higher risk associated with the second aggregated predicted yield to a device associated with the field.

15. The computer-implemented method of claim 1, further comprising:
calculating a recent moisture stress indicator for a recent sub-period later than the first period;
predicting, for each of a recent list of seeding rates, a yield from the recent moisture stress indicator using the trained model;
selecting an optimal seeding rate corresponding to the highest predicted yield among the list of predicted yields;
identifying a risk associated with the highest predicted yield from the risk profile;
the transmitting comprising sending the identified risk to the device associated with the one subfield.

16. One or more non-transitory storage media storing instructions which, when executed by one or more computing devices, cause performance of a method of predicting yields and recommending seeding rates for subfields with informed risks, the method comprising:
receiving weather data for a first period consisting of a plurality of sub-periods for one or more subfields of a field;
for each of the plurality of sub-periods for the one subfield:
calculating a moisture stress indicator from the weather data;
predicting, for each of a list of seeding rates, a yield from the moisture stress indicator using a trained model; and
selecting one of the list of seeding rates based on the list of predicted yields;
identifying one of the predicted yields corresponding to the selected seeding rate;
determining a risk profile associated with a range of yields for the one subfield based on the predicted yields identified for the plurality of sub-periods;
transmitting data related to the risk profile to a device associated with the one subfield.

17. The one or more non-transitory storage media of claim 15,
the weather data including observed soil moisture data for a certain subfield of the one or more subfields,
the calculating comprising estimating soil moisture data for a specific subfield of the one or more subfields from the weather data using a dynamic spatio-temporal model (DSTM).

18. The one or more non-transitory storage media of claim 15, the calculating further comprising:
determining soil moisture for the sub-period for the specific subfield from the weather data;
computing the moisture stress indicator as a percentage of the sub-period when the soil moisture for the one subfield is above a wet threshold or below a dry threshold within the sub-period.

19. The one or more non-transitory storage media of claim 15, the determining further comprising:
for each of the plurality of sub-periods:
aggregating the plurality of identified predicted yields over the one or more subfields; and
aggregating the plurality of selected seeding rates over the one or more subfields;
computing quantiles of the plurality of aggregated predicted yields for the plurality of sub-periods,
the quantile where an aggregated predicted yield belongs indicating a risk associated with the aggregated predicted yield in the risk profile.

20. The one or more non-transitory storage media of claim 19, the method further comprising:
selecting a first aggregated predicted yield that belongs to a lower quantile and a second aggregated predicted yield that belongs to a higher quantile;
identifying a first aggregated seeding rate corresponding to the first aggregated predicted yield and a second aggregated seeding rate corresponding to the second aggregated predicted yield;
transmitting the first seeding rate with a lower risk associated with the first aggregated predicted yield and the second seeding rate with a higher risk associated with the second aggregated predicted yield to a device associated with the field.
